(19) United States
(12) Patent Application Publication
(10) Pub. No.: US 2022/0199108 A1
(43) Pub. Date: Jun. 23, 2022

(54) INFORMATION PROCESSING DEVICE, INFORMATION PROCESSING METHOD, AND PROGRAM

(71) Applicant: SONY GROUP CORPORATION, TOKYO (JP)

(72) Inventor: HIROMI KURASAWA, TOKYO (JP)

(21) Appl. No.: 17/603,980

(22) PCT Filed: Mar. 26, 2020
(86) PCT No.: PCT/JP2020/013875

§ 371 Date: Oct. 15, 2021

(30) Foreign Application Priority Data
Apr. 26, 2019 (JP) 2019-084984

(51) Int. Cl. G10L 25/54; G10L 15/08; G10L 15/22

(52) U.S. Cl. CPC G10L 25/54; G10L 15/08; G10L 2015/223; G10L 2015/221; G10L 15/22

(57) ABSTRACT

It is possible to perform a user speech operation on a voice agent satisfactorily. User speech data and user's shared information are accepted. An analysis result including a speech intention is obtained by analyzing the user speech data in consideration of the user's shared information. The analysis result is output. For example, the user's shared information is a combination of text information and tag information for identifying an information type indicated by the text information. For example, the user's shared information is information indicating a status of a predetermined number of status types. In a speech operation on a voice agent by a user, the user can talk with appropriate omission as in the case of people-to-people conversation, and thus can satisfactorily perform the speech operation.

### TECHNICAL FIELD

The present technology relates to an information processing device, an information processing method, and a program and, more particularly, to an information processing device or the like appropriately applied to an agent system or the like.

### BACKGROUND ART

In recent years, as devices such as home agents have emerged, interactive systems have been introduced at home. Thus, in future, it can be expected that voice agents will be used as interfaces for various devices.

In the case of people-to-people conversation, it is general to determine which information is mutually recognizable and to carry out conversation when talking to a partner based on this shared assumption. For example, what is seen in front of one can be expressed with the demonstrative “that” or a feature can be understood from the partial phrase “those red things”, and in some cases, when people are at the same location, a situation can sometimes be made understandable by partially referring thereto with some omissions.

Similarly, when people talk with machines, people are also likely to estimate “information recognized by machines” and talk with regard to “information which the devices display or which they respond with” or “information controlled by the machines themselves”.

For example, PTL 1 discloses a technology for suggesting a display method of distinguishing corresponding input information through voice recognition from other display information with regard to information displayed on a screen. To handle cases where not all of the information displayed by a device can be input according to voice input, mismatch with respect to a user's expectation is prevented by performing display so that it can be understood what information can be input according to voice input.

### CITATION LIST

### Patent Literature

[PTL 1] JP 2014-202857 A

### SUMMARY

### Technical Problem

The technology described in PTL 1 is a technology for actively presenting an expression which can be accepted as a voice input by an application side to a user. However, according to this technology, a user may not be able to perform various operations with free voices expression and only limited operations may be able to be performed.

In order for an application to present certain information to a user and flexibly understand a speech input of the user in response to the information, it is necessary for a module that understands speech to actively understand what the application is presenting to a user and share information with the user.

However, in general, a normal agent system has a configuration in which a control unit controlling an application itself and a unit interpreting a meaning of speech are different modules. In some cases, there may be a format in which a user has an application in his or her hand on a client side and a unit interpreting a meaning of speech is on a server side and receives speech as an input and simply returns an interpretation results to the client.

In this case, when a control result which has been controlled or information which has been presented to a user is not actively sent to the unit interpreting a meaning of speech, the unit interpreting the meaning of the speech interprets only the speech. If the control result or the like which has been controlled by an application is sent to the unit interpreting the meaning of the speech but information does not have a format which is understandable, the unit interpreting the meaning of the speech cannot accept the information.

An objective of the present technology is to allow a user speech operation with respect to a voice agent to be able to be performed satisfactorily.

### Solution to Problem

According to an aspect of the present technology, an information processing device includes: a speech input unit configured to accept user speech data and user's shared information; a speech analysis unit configured to analyze the user speech data in consideration of the user's shared information and obtain an analysis result including a speech intention; and an analysis result output unit configured to output the analysis result.

In the aspect of the present technology, the speech input unit accepts the user speech data and the user's shared information. The speech analysis unit analyzes the user speech data in consideration of the user's shared information and obtains the analysis result including the speech intention Here, the user's shared information is, for example, information which can be understood as information shared between a user and a system, such as information controlled by an app control unit in presentation of information, in addition to information presented to the user as an image or vocal sound by the app itself. The analysis result output unit outputs the analysis result.

For example, the user's shared information may be a combination of text information and tag information for identifying an information type indicated by the text information. In this case, for example, a synonym may be added to the text information. Thus, it is possible to handle a variation in speech of the user. In this case, for example, the user's shared information may include information which is presented to a user to be recognizable visually or auditorily. Thus, the information presented to the user so that the user can recognize the information visually or auditorily can be handled as information shared with the user.

For example, the user's shared information may be information indicating a status of a predetermined number of status types. In this case, for example, the user's shared information may be a combination of tag information indicating a status type and status information indicating a status for each status type. Thus, the speech analysis unit can appropriately recognize the status of each status type.

In this case, for example, the user's shared information may be information with a predetermined format obtained from information handled by an application, and the speech analysis unit may analyze the user speech data using the information with the predetermined format on the basis of machine learning. In this case, for example, the speech analysis unit may further analyze the user speech data in consideration of a predetermined number of pieces of previous user speech data.

In this way, in the present technology, the user speech data is analyzed in consideration of the user's shared information and the analysis result including the speech intention is obtained. Therefore, in a user's voice operation with the voice agent, the user can talk with appropriate omission as in the case of people-to-people conversation, and thus it is possible to perform the speech operation satisfactorily.

### BRIEF DESCRIPTION OF DRAWINGS

FIG. 1 is a block diagram illustrating an example of a configuration of a voice agent system.

FIG. 2 is a block diagram illustrating an example of a configuration of an app device and an interactive device.

FIG. 3 is a flowchart illustrating an example of a processing procedure of the interactive device.

FIG. 4 is a diagram illustrating an example of an operation of the app device and the interactive device.

FIG. 5 is a diagram illustrating an example of an operation of the app device and the interactive device.

FIG. 6 is a diagram illustrating another example of the operation of the app device and the interactive device.

FIG. 7 is a diagram illustrating examples of kinds of status types.

FIG. 8 is a block diagram illustrating an example of a hardware configuration of a computer.

### DESCRIPTION OF EMBODIMENTS

Hereinafter, modes for carrying out the present invention (hereinafter referred to as embodiments) will be described. The description will be made in the following order.

### 1. EMBODIMENT

### 2. MODIFICATION EXAMPLES

### 1. EMBODIMENT

[Configuration Example of Voice Agent System]

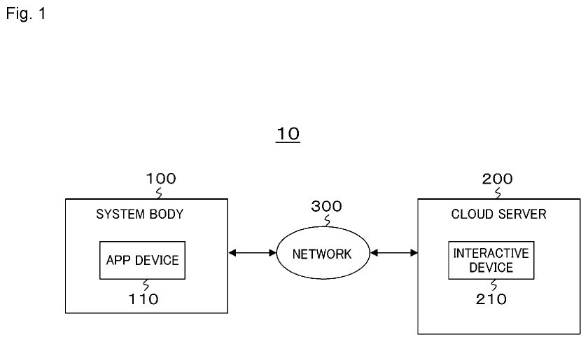

FIG. 1 illustrates an example of a configuration of a voice agent system 10. The voice agent system 10 is configured such that a system body 100 and a cloud server 200 are connected via a network 300 such as the Internet. There is an app device 110 in the system body 100 and there is an interactive device 210 in the cloud server 200.

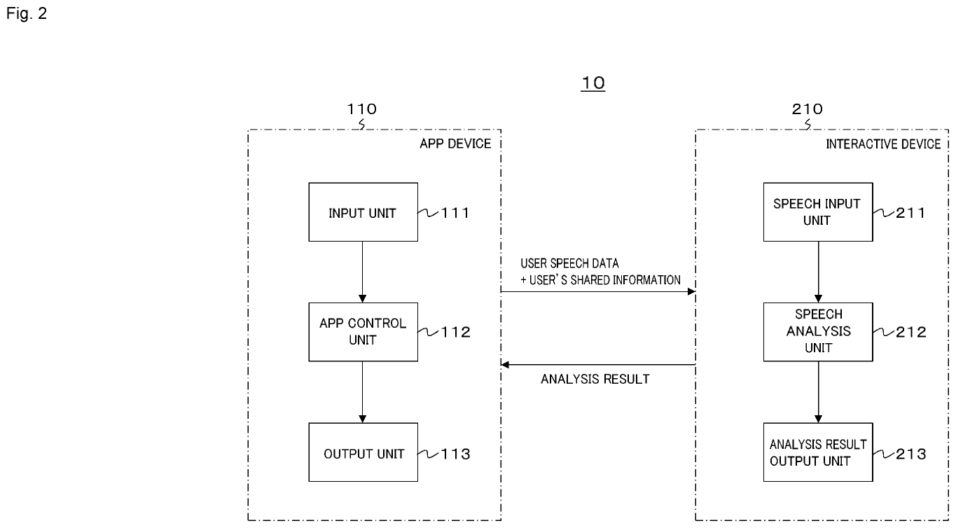

FIG. 2 illustrates an example of a configuration of the app device 110 and the interactive device 210. The app device 110 includes an input unit 111, an app control unit 112, and an output unit 113. The input unit 111 detects speech of a user and transmits voice data corresponding to the speech to the app control unit 112. The input unit 111 is configured by, for example, a microphone.

The app control unit 112 transmits user speech data and user's shared information to the interactive device 210, receives an analysis result including a speech intention from the interactive device 210, performs app control corresponding to the analysis result, and transmits proposal data to the output unit 113 as necessary. The output unit 113 displays an image and/or outputs a vocal sound on the basis of presented information. The output unit 113 is configured by a display or a speaker. Here, as the output unit 113, there are various examples. The app device 110 itself of the system body 100 may include the output unit 113 and the output unit 113 may also be configured by a television receiver, a projector, or the like which is outside of the system body 100.

Here, the user speech data transmitted from the app control unit 112 to the interactive device 210 is voice data corresponding to a user speech or text data obtained through a voice recognition process on the voice data.

When the app control unit 112 does not have a voice processing function, the app control unit 112 may convert the voice data into text data using a voice recognition server. When the app control unit 112 does not have a voice processing function, the app control unit 112 may transmit the voice data to the interactive device 210. In this case, the interactive device 210 converts the voice data into the text data and uses the text data.

Here, the user's shared information includes information which can be understood as information shared between a user and a system, such as information controlled by the app control unit 112 in presentation of information, in addition to information presented as an image or vocal sound by the app device 110 itself (the information which is presented and can be recognized visually or auditorily by the user).

For example, it may be assumed that a response presented to the speech of a user “What will the weather be in Tokyo tomorrow?”, will be “It will be fair”. In this case, the user estimates that the reply is “It will be fair in Tokyo tomorrow”. In this case, “tomorrow” or “Tokyo” is not the presented information but information used to obtain the presented “It will be fair” and information controlled by the app control unit 112.

The interactive device 210 includes a speech input unit 211, a speech analysis unit 212, and an analysis result output unit 213. The speech input unit 211 accepts the pair of user speech data and user's shared information transmitted from the app control unit 112 as an input.

The speech analysis unit 212 analyzes the user speech data in consideration of the user's shared information to obtain an analysis result including a speech intention. The analysis result output unit 213 returns the analysis result obtained by the speech analysis unit 212 to the app control unit 112. In this case, although a general format may be used, a tag indicating the speech intention and one or more arguments are assumed to be returned here. An argument is assumed to be a pair of an argument item name and a vocabulary item.

Although not described above, it is conceivable that the app control unit 112 of the app device 110 inside the system body 100 be on the side of the cloud server 200. Although not described above, it is also conceivable that the interactive device 210 is on the side of the system body 100 as in the app device 110.

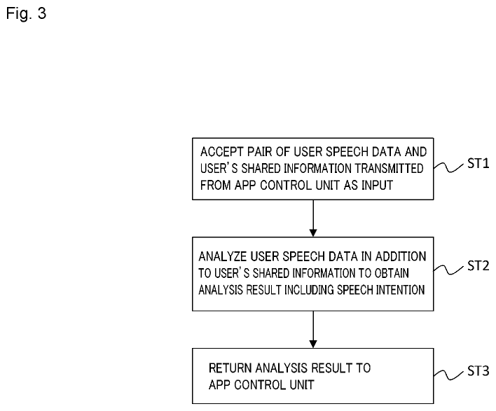

The flowchart of FIG. 3 illustrates an example of a processing procedure of the interactive device 210. In step ST1, the speech input unit 211 of the interactive device 210 accepts the pair of user speech data and user's shared information transmitted from the app control unit 112 as an input.

Subsequently, in step ST2, the speech analysis unit 212 of the interactive device 210 analyzes the use speech data in consideration of the user's shared information to obtain the analysis result including the speech intention. In step ST3, the analysis result output unit 213 of the interactive device 210 returns the analysis result to the app control unit 112.

### Example 1

Next, an example of an operation between the app device 110 and the interactive device 210 will be described. This example is an example in which the user's shared information is a combination of the text information and tag information for identifying an information type indicated by the text information.

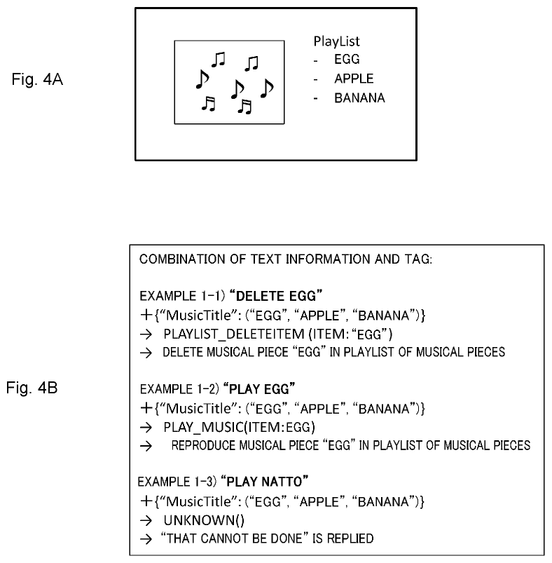

A case will be considered in which a playlist of musical pieces to be reproduced is displayed on a display configured as the output unit 113 of the app device 110, as illustrated in FIG. 4(a). The playlist includes musical pieces of “EGG”, “APPLE”, and “BANANA”.

For example, when the user says “DELETE EGG”, as illustrated in Example 1-1 of FIG. 4(b), tag information “MusicTitle” and text information “EGG”, “APPLE”, and “BANANA” are transmitted from the app control unit 112 to the interactive device 210 along with the speech.

In this case, the speech analysis unit 212 of the interactive device 210 analyzes “EGG” as a musical piece, obtains the analysis result indicating an operation to delete the musical piece “EGG” from the playlist of the musical pieces, and returns the analysis result to the app control unit 112. The analysis result returned to the app control unit 112 is formed by “PLAYLIST_DELETEITEM” which is a tag indicating a speech intention and ‘ITEM: “EGG”’ which is an argument. In the argument, “ITEM” is an argument item name and “EGG” is a vocabulary item.

Thus, the app control unit 112 to which the analysis result is returned performs control such that the musical piece “EGG” in the playlist of the musical pieces is deleted.

For example, when the user says “PLAY EGG”, as illustrated in Example 1-2 of FIG. 4(b), tag information “MusicTitle” and the text information “EGG”, “APPLE”, and “BANANA” are transmitted from the app control unit 112 to the interactive device 210 along with the speech.

In this case, the speech analysis unit 212 of the interactive device 210 analyzes “EGG” as a musical piece, obtains the analysis result indicating an operation to reproduce the musical piece “EGG”, and returns the analysis result to the app control unit 112. The analysis result returned to the app control unit 112 is formed by “PLAY_MUSIC” which is a tag indicating a speech intention and ‘ITEM: “EGG”’ which is an argument.

Thus, the app control unit 112 to which the analysis result is returned performs control such that the musical piece “EGG” in the playlist of the musical pieces is reproduced.

For example, when the user says “PLAY NATTO”, as illustrated in Example 1-3 of FIG. 4(b), tag information “MusicTitle” and the text information “EGG”, “APPLE”, and “BANANA” are transmitted from the app control unit 112 to the interactive device 210 along with the speech.

In this case, the speech analysis unit 212 of the interactive device 210 analyzes that “NATTO” is a common noun because a musical piece “NATTO” is not included in the playlist of the musical pieces and is not shared with the user, and returns “UNKNOWNO” indicating an unclear meaning as an analysis result to the app control unit 112. Based on this, the app control unit 112 performs control such that, for example, “THAT CANNOT BE DONE” is replied.

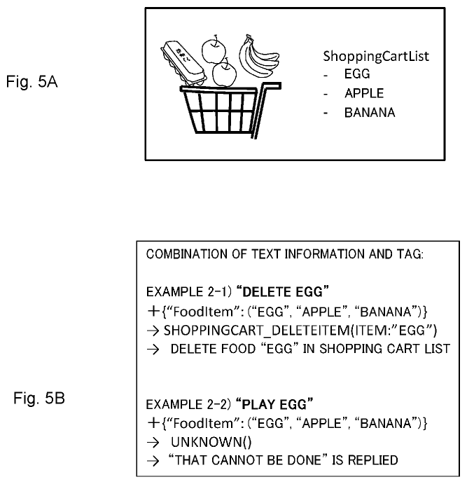

Next, a case will be considered in which a shopping cart list is displayed on the display configured as the output unit 113 of the app device 110, as illustrated in FIG. 5(a). The shopping cart list includes food of “EGG”, “APPLE”, and “BANANA”.

For example, when the user says “DELETE EGG”, as illustrated in Example 2-1 of FIG. 5(b), tag information “Fooffltem” and text information “EGG”, “APPLE”, and “BANANA” are transmitted from the app control unit 112 to the interactive device 210 along with the speech.

In this case, the speech analysis unit 212 of the interactive device 210 analyzes “EGG” as food, obtains the analysis result indicating an operation to delete the food “EGG” from the shopping cart list, and returns the analysis result to the app control unit 112. The analysis result returned to the app control unit 112 is formed by “SHOPPINGCART_DELETEITEM” which is a tag indicating a speech intention and ‘ITEM: “EGG”’ which is an argument.

Thus, the app control unit 112 to which the analysis result is returned performs control such that the food “EGG” in the shopping cart list is deleted.

For example, when the user says “PLAY EGG”, as illustrated in Example 2-2 of FIG. 5(b), tag information “FoodItem” and the text information “EGG”, “APPLE”, and “BANANA” are transmitted from the app control unit 112 to the interactive device 210 along with the speech.

In this case, the speech analysis unit 212 of the interactive device 210 analyzes “EGG” as a topic of food and returns “UNKNOWNO” indicating an unclear meaning as an analysis result to the app control unit 112. Based on this, the app control unit 112 performs control such that, for example, “THAT CANNOT BE DONE” is replied. That is, in this case, even when there is a musical piece “EGG”, the musical piece is not reproduced.

In the above description, user's shared information has a format in which the text information is appended to the tag information. For example, there is {“MusicTitle”: (“EGG”, “APPLE”, “BANANA”)}. However, the user's shared information may have a format in which the tag information is appended for each piece of text information. For example, {“EGG”: “MusicTitle”, “APPLE”,: “MusicTitle”, “BANANA”: “MusicTitle”} may be used.

Although not described above, a synonym may be appended to the text information. Here, a synonym means an expression which a user may say instead of an expression indicated by the text information. For example, when the playlist illustrated in FIG. 4(a) is displayed on the display, there is also a probability of the user saying “PLAY No. 1” or the like instead of “PLAY EGG”. In this case, “No. 1”, “EGG”, or the like can be a synonym “EGG”. By adding a synonym to the text information in this way, it is possible to handle a variation in a speech expression of the user satisfactorily.

### Example 2

Next, another example of an operation between the app device 110 and the interactive device 210 will be described. This example is an example in which the user's shared information is formed by information indicating a status of a predetermined number of status types. Here, the status type is a type of status. In this case, the user's shared information is, for example, a combination of tag information indicating a status type and status information (a status sign) indicating a status for each status type.

Here, three statuses, for example, a screen status, a volume status, and a performance status, are handled as the status types. In the screen status, the status information indicates which display is realized on a display configured as the output unit 113 of the app device 110. The status information indicates whether the volume status has reached a volume adjustment status. The status information indicates whether the performance status has reached the musical piece reproduction status.

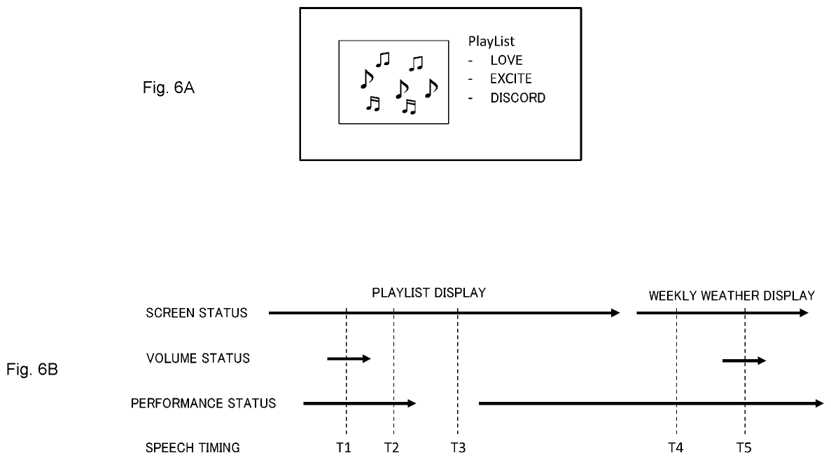

In FIG. 6(a), a playlist of musical pieces to be reproduced is displayed on the display. In this case, the status information indicates a playlist display status. The illustrated playlist includes musical pieces of “LOVE”, “EXCITE”, and “DISCORD”.

Here, the screen status, the volume status, and the performance status can be changed through an operation by the user and are user's shared information. FIG. 6(b) illustrates examples of changes in the screen status, the volume status, and the performance status and speech timings of the user. A speech changing the statuses can be highly likely to be produced by the user. Herein, description of the speech will be omitted. For example, it is assumed that a change to a reproduction status of a musical piece is automatically performed by the app control unit 112 at a preset time. However, the change is normally performed based on speech of the user. For the screen status, a period of an arrow indicates a status of each of playlist display or weekly weather display. For the performance status, a period of an arrow indicates a reproduction status of a musical piece.

For the volume status, a start timing of the arrow is a timing at which the volume status has reached a volume adjustment status and a period of the arrow indicates, for example, a given period in which the user does not forget to adjust volume because of the volume display on the display. The given period is set arbitrarily and is a period in which there is a probability of the user saying with a shortened expression about the volume adjustment.

At a speech timing T1, the screen status is a playlist display status of a musical piece of a music app and the volume status is a volume adjustment status, and the performance status is a reproduction status of the musical piece. In this case, a probability of the user mentioning all the statuses is assumed, and even when an immediately previous speech is speech for a volume adjustment request, the speech may be a reproduction stop request for the musical piece or may be a request for reproducing another musical piece which is displayed on a screen and is not in a reproduction status.

At a speech timing T2, the screen status is a playlist display status of the musical piece of the music app, the volume status is a volume non-adjustment status, and the performance status is a reproduction status of the musical piece. At a speech timing T3, the screen status is a playlist display status of the musical piece of the music app, the volume status is a volume non-adjustment status, and the performance status is a reduction stop status of the musical piece.

At a speech timing T4, the screen status is a weekly weather display status, the volume status is a volume non-adjustment status, and the performance status is a reproduction status of the musical piece. At a speech timing T5, the screen status is a weekly weather display status, the volume status is a volume adjustment status, and the performance status is a reproduction status of the musical piece.

In this case, at a speech timing T1, information indicating each of the screen status, the volume status, and the performance status is transmitted along with the speech of the user from the app control unit 112 to the interactive device 210. At this time, the information indicating the screen status is formed by a pair of “DisplayStatus” serving as tag information indicating a status type and “MusicPlayList” serving as status information indicating a playlist display status.

The information indicating the volume status is formed by a pair of “VolumeStatus” serving as tag information indicating a status type and “CurrentlyChanged” serving as status information indicating a volume adjustment status. The information indicating the performance status is formed by a pair of “PlayingStatus” serving as tag information indicating a status type and “PlayingMusic” serving as status information indicating a reproduction status.

At the speech timing T2, information indicating each of the screen status, the volume status, and the performance status is also transmitted along with the speech of the user from the app control unit 112 to the interactive device 210. At this time, the information indicating the screen status is formed by a pair of “DisplayStatus” serving as tag information indicating a status type and “MusicPlayList” serving as status information indicating a playlist display status.

The information indicating the volume status is formed by a pair of “VolumeStatus” serving as tag information indicating a status type and “CurrentlyNotChanged” serving as status information indicating a volume non-adjustment status. The information indicating the performance status is formed by a pair of “PlayingStatus” serving as tag information indicating a status type and “PlayingMusic” serving as status information indicating a reproduction status.

At the speech timing T3, information indicating each of the screen status, the volume status, and the performance status is also transmitted along with the speech of the user from the app control unit 112 to the interactive device 210. At this time, the information indicating the screen status is formed by a pair of “DisplayStatus” serving as tag information indicating a status type and “MusicPlayList” serving as status information indicating a playlist display status.

The information indicating the volume status is formed by a pair of “VolumeStatus” serving as tag information indicating a status type and “CurrentlyNotChanged” serving as status information indicating a volume non-adjustment status. The information indicating the performance status is formed by a pair of “PlayingStatus” serving as tag information indicating a status type and “StopingMusic” serving as status information indicating a non-reproduction status.

At the speech timing T4, information indicating each of the screen status, the volume status, and the performance status is also transmitted along with the speech of the user from the app control unit 112 to the interactive device 210. At this time, the information indicating the screen status is formed by a pair of “DisplayStatus” serving as tag information indicating a status type and “WeeklyWeather” serving as status information indicating a weekly weather display status.

The information indicating the volume status is formed by a pair of “VolumeStatus” serving as tag information indicating a status type and “CurrentlyNotChanged” serving as status information indicating a volume non-adjustment status. The information indicating the performance status is formed by a pair of “PlayingStatus” serving as tag information indicating a status type and “PlayingMusic” serving as status information indicating a reproduction status.

At the speech timing T5, information indicating each of the screen status, the volume status, and the performance status is transmitted along with the speech of the user from the app control unit 112 to the interactive device 210. At this time, the information indicating the screen status is formed by a pair of “DisplayStatus” serving as tag information indicating a status type and “WeeklyWeather” serving as status information indicating a weekly weather display status.

The information indicating the volume status is formed by a pair of “VolumeStatus” serving as tag information indicating a status type and “CurrentlyChanged” serving as status information indicating a volume adjustment status. The information indicating the performance status is formed by a pair of “PlayingStatus” serving as tag information indicating a status type and “PlayingMusic” serving as status information indicating a reproduction status.

The speech analysis unit 212 of the interactive device 210 analyzes the user speech data in consideration of the user's shared information (information indicating each of the screen status, the volume status, the performance status), obtains the analysis result including the speech intention, and returns the analysis result to the app control unit 112.

For example, when speech of the user is “set to 2”, the speech analysis unit 212 interprets the user speech data as a meaning for requesting an operation to changing the volume to “2”, obtains the analysis result indicating an instruction to perform the operation of changing the volume to “2”, and returns the analysis result to the app control unit 112 at the speech timings T1 and T5 because of the volume adjustment status. Thus, the app control unit 112 to which the analysis result is returned performs control such that the volume is changed to “2”.

In this case, at the speech timings T2 and T3, because of the volume non-adjustment status and the display status of the playlist, the speech analysis unit 212 analyzes the user speech data as a meaning for reproducing a musical piece of No. 2 in the playlist, obtains the analysis result indicating an instruction to perform an operation of reproducing the musical piece of No. 2 of the playlist, and returns the analysis result to the app control unit 112. Thus, the app control unit 112 to which the analysis result is returned performs control such that the musical piece of No. 2 of the playlist is reproduced.

In this case, at the speech timing T4, because of the volume non-adjustment status and the display status of the weekly weather, the speech analysis unit 212 analyzes the user speech data as an unclear meaning and returns an analysis result of the unclear meaning to the app control unit 112. Based on this, the app control unit 112 performs control such that, for example, “THAT CANNOT BE DONE” is replied.

For example, when speech of the user is “Tokyo”, the speech analysis unit 212 analyzes that a music topic is preferred, a music name is “Tokyo”, and a request for displaying the musical piece “Tokyo” is made, obtains the analysis result indicating an instruction to perform an operation of displaying the musical piece “Tokyo”, and returns the analysis result to the app control unit 112 because of the playlist display status at the speech timings T1, T2, and T3. Thus, the app control unit 112 to which the analysis result is returned performs control such that the musical piece “Tokyo” is displayed.

In this case, at the speech timings T4 and T5, because of the weekly weather display status, the speech analysis unit 212 analyzes that the screen status is preferred rather than the performance status even in the reproduction status of the musical piece and a request for checking weather of “Tokyo” is made, obtains the analysis result indicating an instruction to perform an operation of checking the weather of “Tokyo”, and returns the analysis result to the app control unit 112. Thus, the app control unit 112 to which the analysis result is returned performs control such that the weather of “Tokyo” is checked.

It is also conceivable that the speech analysis unit 212 can return both the analysis result indicating the instruction to perform an operation of displaying the musical piece “Tokyo” and the analysis result indicating the instruction to perform an operation of checking the weather of “Tokyo” without preferring the screen status to the app control unit 112 and the side of the app device 110 can select one of the analysis results.

For example, when speech of the user is “stop”, the speech analysis unit 212 analyzes that a request for stopping the reproduction of the musical piece is made, obtains an analysis result indicating an instruction to stop the reproduction of the musical piece, obtains the analysis result indicating an instruction to perform an operation of stopping reproduction of the musical piece, and returns the analysis result to the app control unit 112 at the speech timings T1 and T2 because of the playlist display status and the reproduction status of the musical piece. Thus, the app control unit 112 to which the analysis result is returned performs control such that the reproduction of the musical piece is stopped.

In this case, at the speech timing T3, because of the playlist display status and the non-reproduction status of the musical piece, the speech analysis unit 212 analyzes the user speech data as an unclear meaning and returns an analysis result of the unclear meaning to the app control unit 112. Based on this, the app control unit 112 performs control such that, for example, “THAT CANNOT BE DONE” is replied.

In this case, at the speech timings T4 and T5, because of the weekly weather display status and the reproduction status of the musical piece, the speech analysis unit 212 analyzes that the musical piece reproduction status is preferred and a request for stopping the reproduction of the musical piece is made, obtains the analysis result indicating an instruction to perform the operation of stopping the reproduction of the musical piece, and returns the analysis result to the app control unit 112. Thus, the app control unit 112 to which the analysis result is returned performs control such that the reproduction of the musical piece is stopped.

The example in which the speech analysis unit 212 of the interactive device 210 analyzes the user speech data at any speech timing in consideration of the user's shared information (the status information of the predetermined number of status types) transmitted in combination of the user's speech data has been described above.

It is also conceivable that the speech analysis unit 212 performs analysis in consideration of a predetermined number of pieces of past user speech data. For example, in the above-described example, the volume status is the volume adjustment status “CurrentlyChanged” for the given period (the period indicated with the length of the arrow) after having reached the volume adjustment status on the side of the app control unit 112, but it is better to authorize the side of the speech analysis unit 212 to keep the volume adjustment status for a certain period after entering the volume status to the volume adjustment status due to a speech of the user.

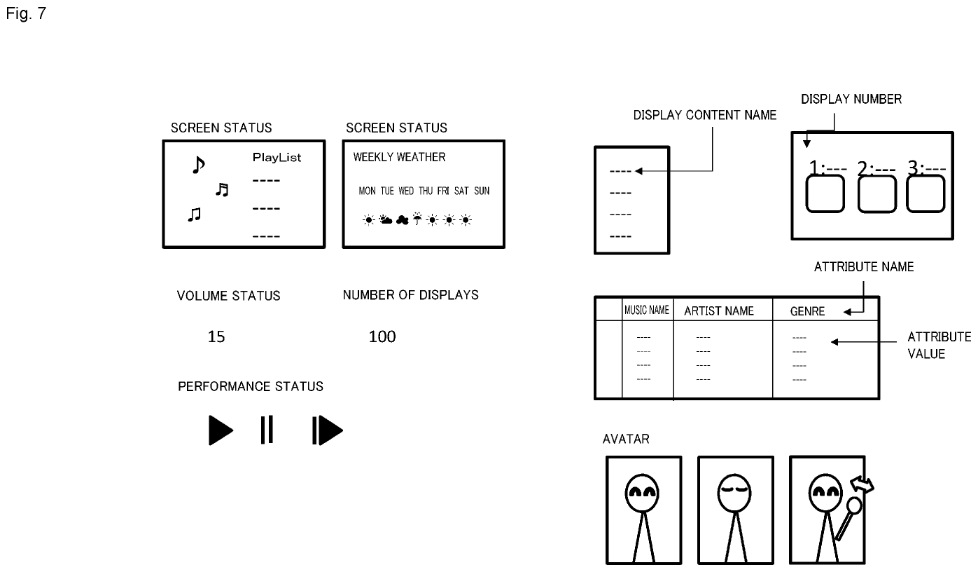

The example in which the three statuses, the screen status, the volume status, and the performance status, are handled as the status types has been described above. However, the status types are not limited thereto. For example, as illustrated in FIG. 7, other status types such as a display content name, a display content attribute value, a display content attribute name, the number of displays, a display number, and an avatar are also conceivable in addition to the screen status, the volume status, and the performance status.

The example in which the user's shared information is a combination of the tag information indicating the status type and the status information (the status sign) indicating the status for each status type has been described above. However, it is also conceivable that the user's shared information is set as information that has a predetermined format (for example, a vector expression) obtained from information handled by an application.

In this case, signal information which is an original of diverse status types is set as, for example, information that has a predetermined format (for example, a vector expression) obtained based on a result learned using each status of the system instead of directly having a format of information understood in a portion in which a meaning of speech is interpreted. In this case, it is also conceivable that the speech analysis unit 212 analyzes the user speech data using the information with the predetermined format on the basis of, for example, machine learning.

As described above, in the voice agent system 10 illustrated in FIGS. 1 and 2, the speech analysis unit 212 of the interactive device 210 analyzes the user speech data in consideration of the user's shared information and obtains the analysis result including a speech intention. Therefore, in a user's voice operation with the voice agent, the user can talk with appropriate omission as in the case of people-to-people conversation, and thus it is possible to perform the speech operation satisfactorily.

### 2. MODIFICATION EXAMPLES

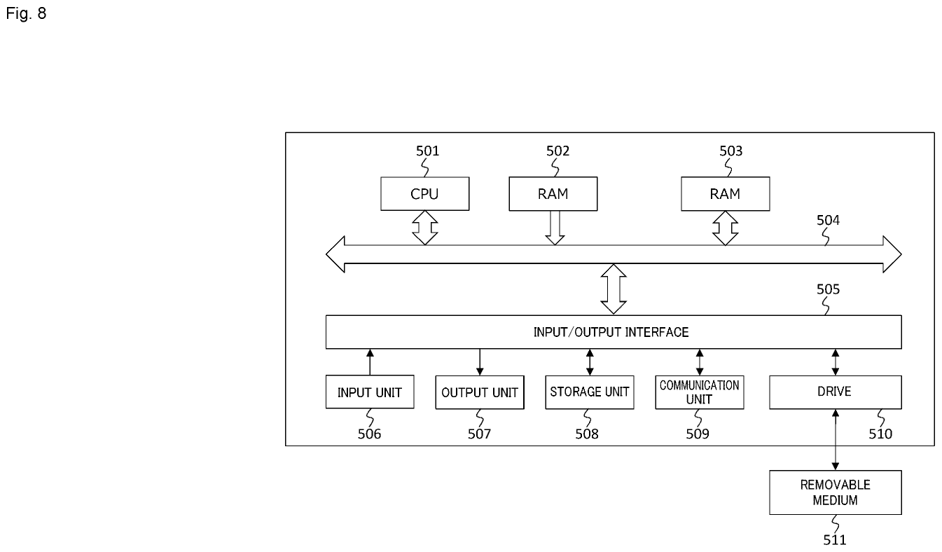

FIG. 8 is a block diagram illustrating an example of a hardware configuration of a computer which a program causes to perform the above-described series of processes. For example, the app device 110 or the interactive device 210 illustrated in FIG. 2 can be configured as a computer.

In the computer, a central processing unit (CPU) 501, a read-only memory (ROM) 502, and a random access memory (RAM) 503 are connected to each other by a bus 504. An input/output interface 505 is further connected to the bus 504. An input unit 506, an output unit 507, a storage unit 508, a communication unit 509, and a drive 510 are connected to the input/output interface 505.

The input unit 506 is a keyboard, a mouse, a microphone, or the like. The output unit 507 is a display, a speaker, or the like. The storage unit 508 is a hard disk, a nonvolatile memory, or the like. The communication unit 509 is a network interface or the like. The drive 510 drives a removable medium 511 such as a magnetic disk, an optical disc, a magneto-optical disk, or a semiconductor memory.

In the computer that has the above configuration, for example, the CPU 501 performs the above-described series of processes by loading a program stored in the storage unit 508 to the RAM 503 via the input/output interface 505 and the bus 504 and executing the program.

The program executed by the computer (the CPU 501) can be recorded on, for example, the removable medium 511 serving as a package medium for supply. The program can be supplied via a wired or wireless transfer medium such as a local area network, the Internet, or digital satellite broadcasting.

In the computer, by mounting the removable medium 511 on the drive 510, it is possible to install the program in the storage unit 508 via the input/output interface 505. The program can be received by the communication unit 509 via a wired or wireless transfer medium to be installed in the storage unit 508. In addition, the program can be installed in advance in the ROM 502 or the storage unit 508.

The program executed by the computer may be a program that performs processes chronologically in the procedure described in the present specification or may be a program that performs a process at a necessary timing such as in parallel or upon being called.

The preferred embodiment of the present disclosure has been described in detail with reference to the appended drawings, but the technical scope of the present disclosure is not limited to the example. It should be apparent to those skilled in the art in the technical fields of the present disclosure that various change examples or correction examples can be made within the scope of the technical spirit described in the claims and are, of course, construed to belong to the technical scope of the present disclosure.

The present technology can be configured as follows.

(1)

An information processing device including:

a speech input unit configured to accept user speech data and user's shared information;

a speech analysis unit configured to analyze the user speech data in consideration of the user's shared information and obtain an analysis result including a speech intention; and

an analysis result output unit configured to output the analysis result.

(2)

The information processing device according to (1), wherein the user's shared information is a combination of text information and tag information for identifying an information type indicated by the text information.

(3)

The information processing device according to (2), wherein a synonym is added to the text information.

(4)

The information processing device according to (2) or (3), wherein the user's shared information includes information which is presented to a user to be recognizable visually or auditorily.

(5)

The information processing device according to (1), wherein the user's shared information is information indicating a status of a predetermined number of status types.

(6)

The information processing device according to (5), wherein the user's shared information is a combination of tag information indicating a status type and status information indicating a status for each status type.

(7)

The information processing device according to (5) or (6), wherein the status type includes at least one of a screen status, a volume status, a performance status.

(8)

The information processing device according to claim 7, wherein, when the status type is the screen status, the status information indicates a display status of a music play list or weather forecast.

(9)

The information processing device according to (5),

wherein the user's shared information is information with a predetermined format obtained from information handled by an application, and

wherein the speech analysis unit analyzes the user speech data using the information with the predetermined format on the basis of machine learning.

(10)

The information processing device according to any one of (5) to (9), wherein the speech analysis unit further analyzes the user speech data in consideration of a predetermined number of pieces of previous user speech data.

(11)

An information processing method including:

a procedure of accepting user speech data and user's shared information;

a procedure of obtaining an analysis result including a speech intention by analyzing the user speech data in consideration of the user's shared information; and

a procedure of outputting the analysis result.

(12)

A program causing a computer to function as:

speech input means for accepting user speech data and user's shared information;

speech analysis means for obtaining an analysis result including a speech intention by analyzing the user speech data in consideration of the user's shared information; and

analysis result output means for outputting the analysis result.

### REFERENCE SIGNS LIST

10 Voice agent system

100 System body

110 App device

111 Input unit

112 App control unit

113 Output unit

200 Cloud server

210 Interactive device

211 Speech input unit

212 Speech analysis unit

213 Analysis result output unit

300 Network

1. An information processing device comprising:
a speech input unit configured to accept user speech data and user's shared information;
a speech analysis unit configured to analyze the user speech data in consideration of the user's shared information and obtain an analysis result including a speech intention; and
an analysis result output unit configured to output the analysis result.

2. The information processing device according to claim 1, wherein the user's shared information is a combination of text information and tag information for identifying an information type indicated by the text information.

3. The information processing device according to claim 2, wherein a synonym is added to the text information.

4. The information processing device according to claim 2, wherein the user's shared information includes information which is presented to a user to be recognizable visually or auditorily.

5. The information processing device according to claim 1, wherein the user's shared information is information indicating a status of a predetermined number of status types.

6. The information processing device according to claim 5, wherein the user's shared information is a combination of tag information indicating a status type and status information indicating a status for each status type.

7. The information processing device according to claim 5, wherein the status type includes at least one of a screen status, a volume status, a performance status.

8. The information processing device according to claim 7, wherein, when the status type is the screen status, the status information indicates a display status of a music play list or weather forecast.

9. The information processing device according to claim 5,
wherein the user's shared information is information with a predetermined format obtained from information handled by an application, and
wherein the speech analysis unit analyzes the user speech data using the information with the predetermined format on the basis of machine learning.

10. The information processing device according to claim 5, wherein the speech analysis unit further analyzes the user speech data in consideration of a predetermined number of pieces of previous user speech data.

11. An information processing method comprising:
a procedure of accepting user speech data and user's shared information;
a procedure of obtaining an analysis result including a speech intention by analyzing the user speech data in consideration of the user's shared information; and
a procedure of outputting the analysis result.

12. A program causing a computer to function as:
speech input means for accepting user speech data and user's shared information;
speech analysis means for obtaining an analysis result including a speech intention
by analyzing the user speech data in consideration of the user's shared information; and
analysis result output means for outputting the analysis result.
